(19) United States
(12) Patent Application Publication
(10) Pub. No.: US 2018/0207895 A1
(43) Pub. Date: Jul. 26, 2018

(54) CARDBOARD WITH EDGE SEALED WITH MIXTURE OF HOT-MELT ADHESIVE AND WAX

(71) Applicant: Chi-Wah LAU, Hong Kong (HK)

(72) Inventor: Chi-Wah LAU, Hong Kong (HK)

(21) Appl. No.: 15/590,050

(22) Filed: May 9, 2017

(30) Foreign Application Priority Data
Jan. 26, 2017 (TW) 106103147

(51) Int. Cl. B31B 50/62; B31B 50/64; C09J 123/00

(52) U.S. Cl. CPC B31B 50/62; B31B 50/64; C09J 123/00; B31B 50/642

(57) ABSTRACT

Cardboard with edges sealed by a mixture of hot-melt adhesive and wax includes two surface sheets and an intermediate core material. The surface sheets have a pair of corresponding edges that form an edge opening therebetween communicating with the interstitial spaces in the cardboard and sealed by an edge-sealing structure in the interstitial spaces. The edge-sealing structure includes a primer layer formed by an adhesive mixture and a sealing layer formed by a sealing mixture. The adhesive mixture is made by mixing the hot-melt adhesive with the wax, adhesively bonds the surface sheets and the intermediate core material together, and forms the primer layer with voids and providing a porous supporting surface to be coated with the sealing mixture. The sealing mixture is less adhesive than the adhesive mixture and fills up the voids in the primer layer. Thus, the cardboard achieves waterproofness and thermal and acoustic insulation at low cost.

### FIELD OF THE INVENTION

The present invention relates to cardboard with edges sealed with a mixture of a hot-melt adhesive and wax. More particularly, the invention relates to cardboard whose internal interstitial spaces are sequentially sealed with an adhesive mixture and a sealing mixture to form a waterproof edge-sealing structure, wherein both the adhesive mixture and the sealing mixture are made by mixing a hot-melt adhesive with wax, the adhesive mixture being more adhesive than the sealing mixture and forming a primer layer with a plurality of voids, the sealing mixture filling up the voids in the primer layer to provide water tightness and thereby protect the cardboard from being dampened by moisture.

### BACKGROUND OF THE INVENTION

Corrugated cardboard is composes of a fluted paper core material sandwiched and bonded between two planar paper surface sheets, forming parallel rows of air columns between the core material and the surface sheets. The air columns make up 60% to 70% of the structural volume of corrugated cardboard providing lightweight, insulating and shock absorbing characteristics, thus making cardboard an ideal material for making shipping boxes, known as corrugated boxes.

Despite the foregoing advantages, however, corrugated boxes have drawbacks in use attributable mainly to their lack of “moisture resistance”. Once a corrugated box adsorbs moisture, its structural strength plummets, meaning the corrugated box may collapse easily. Since dampness or moisture is almost certain to be found on the surface of such goods as seafood and fresh produce during transportation, and common corrugated boxes do not provide sufficient thermal insulation, condensation tends to occur and produce water droplets on the inner and outer walls of such a corrugated box due to a gradual rise in temperature of the contents (For example, seafood) of the box during long-distance transport, or as a result of the temperature difference, condensation build up between the box's interior and the outside. Dampened boxes break more easily and more frequently during handling, and collapse during stacking.

To address the issue of “moisture resistance”, a coating method and wax dipping method are commonly used in the prior art to address the aforementioned problem of moisture resistance. Coating method is an economical solution, which hot rolls a layer of molten wax on the outside surfaces of the corrugated cardboard, thus both inside and outside surfaces of the corrugated boxes are protected from moisture. FIG. 1 schematically shows the structure of a piece of conventional corrugated cardboard 1 (which can be shaped into a corrugated box by folding and which is depicted only partially to reveal its structural details). The corrugated cardboard 1 includes two surface sheets 11, 12 and a core material 13. One of the surface materials, for example, 11, is coated with wax on the outer side to form a waterproof layer 14 that can protect the corrugated cardboard 1 from being dampened by moisture after the corrugated cardboard 1 is folded into a corrugated box.

However, the edges of the corrugated cardboard remains uncovered, exposing the air columns to external air. Moisture in the external air can readily infiltrates the air columns, condenses to water and weakens the structural integrity of the corrugated boxes when the core material becomes wet. With continued reference to FIG. 1, the corrugated cardboard 1 is formed with an edge opening 101 (also referred to as a cross section) along an edge that is parallel to the corrugation direction (i.e., the direction in which the core material 13 extends in a wavy manner). In addition, the corrugated cardboard 1 is formed with a corrugation-direction opening 102 (also referred to as a longitudinal section) along an edge that is perpendicular to the corrugation direction. As can be clearly seen in the drawing, the edge opening 101 does not have a flat surface inside (but includes gaps separated by the corrugated core material 13), so it is impossible to coat this opening with wax, let alone form the waterproof layer 14 in the opening.

Furthermore, the core material 13 adsorbs wax. Even if a manufacturer manages to coat the edge opening 101 with wax, the wax will seep into the core material 13 rather than form the desired waterproof layer in the edge opening 101. In other words, the edge opening 101 becomes a weakness in waterproofing, and this problem cannot be solved simply by coating with wax. Currently, a manufacturer wishing to meet the production requirements of highly moisture-resistant corrugated boxes must use the other method. For example, the wax dipping method shower sprays the entire cardboard with molten wax. Thus, the surfaces, as well as the edges, of the cardboard are covered in wax, significantly improving moisture resistance. However, the molten wax also flows into and fills the air columns by capillary action, consuming much more wax, adding more weight to the cardboard (by about 50%), and thus significantly increasing the cost of manufacturing and shipping (at least twofold).

According to the above, the existing corrugated boxes fail to meet the requirements of “moisture resistance” and “low material cost” at the same time. As a perfectly waterproof wax layer cannot be formed on a corrugated box without using a considerable amount of wax and increasing the weight of the corrugated box, coating with wax is by no means an ideal solution. Besides, the inventor of the present invention has found that a waterproof layer of wax, which cannot reduce heat transfer, remains inadequate in terms of thermal insulation during freight transport. For example, seafood and fresh produce (For example, meat and dairy products) will spoil during long-distance transportation because of a temperature rise (i.e., failure to keep the goods refrigerated), and an overly high or exceeding low temperature (i.e., failure to maintain a constant temperature) will have adverse effects on red wine, flowers, drugs, and so on.

Accordingly, the issue to be solved by the present invention is to improve the conventional corrugated cardboard 1 by sealing its edge opening 101 in a way that is easy to implement and helpful in material cost control, thereby effectively enhancing moisture resistance and thermal insulation (hopefully also acoustic insulation and impact resistance) of the corrugated cardboard 1.

### BRIEF SUMMARY OF THE INVENTION

In view of the fact that the existing corrugated cardboard for making corrugated boxes has edge openings where a waterproof wax layer cannot be formed, and that therefore it is conventionally required to waterproof such corrugated cardboard by submerging it entirely in wax, which however is a costly process, the inventor of the present invention put years of practical experience into extensive research and repeated trials and finally succeeded in developing cardboard with edges sealed with a mixture of a hot-melt adhesive and wax to effectively overcome the aforesaid drawbacks of the prior art.

It is an objective of the present invention to provide cardboard (For example, corrugated cardboard) having edges sealed with a mixture of a hot-melt adhesive and wax. The cardboard at least includes a first surface sheet, a second surface sheet, and an intermediate core material provided between the surface sheets. Each of the top and bottom sides of the intermediate core material forms at least one interstitial space with the corresponding surface sheet. The surface sheets have a pair of corresponding edges that form an edge opening there between, wherein the edge opening is in communication with the interstitial spaces. The cardboard is characterized in that the interstitial spaces are provided with an edge-sealing structure for sealing the edge opening. The edge-sealing structure includes a primer layer and a sealing layer. The primer layer is formed by an adhesive mixture and the adhesive mixture is made by mixing a hot-melt adhesive with wax, this function will work as a layer of barrier to stop the second layer of hot wax sip further into the corrugated section. Where in the hot-melt adhesive makes up 10% to 65% by weight of the adhesive mixture. The adhesive mixture is applied to the edge opening to adhesively bond the surface sheets and the intermediate core material together, and when cured, the adhesive mixture forms the primer layer with a plurality of voids. The sealing layer is formed by a sealing mixture, and is also made by mixing the hot-melt adhesive (which may be a mixture of different hot-melt adhesives) with the wax, and the hot-melt adhesive makes up only 5% to 40% by weight of the sealing mixture. The hot-melt adhesive in the sealing mixture, are lighter than the adhesive mixture this will also help the sealing mixture flow on top of the layer of adhesive mixture. Than when the sealing mixture is applied to the primer layer to fill up the voids that correspond to the edge opening, will form as the sealing layer. As the hot-melt adhesive are immediately glue to the surface of the cross section of the corrugate “so it will not be able to absorb by the intermediate core material”, the adhesive mixture can form as a supporting primer layer in the edge opening, only allowing the sealing mixture to be applied to the primer layer and thereby seal the edge opening. Thus, moisture resistance of the cardboard is effectively enhanced without having to submerge the cardboard in a large amount of wax.

### BRIEF DESCRIPTION OF THE SEVERAL VIEWS OF THE DRAWINGS

The working principle, structural features, and objectives of the present invention can be better understood by referring to the following detailed description of an illustrative embodiment in conjunction with the accompanying drawings, in which:

FIG. 1 schematically shows a piece of conventional corrugated cardboard;

FIG. 2 schematically shows the structure of a piece of corrugated cardboard according to the present invention; and

FIG. 3A to FIG. 3C schematically show how the edge-sealing structure of the present invention is formed.

### DETAILED DESCRIPTION OF THE INVENTION

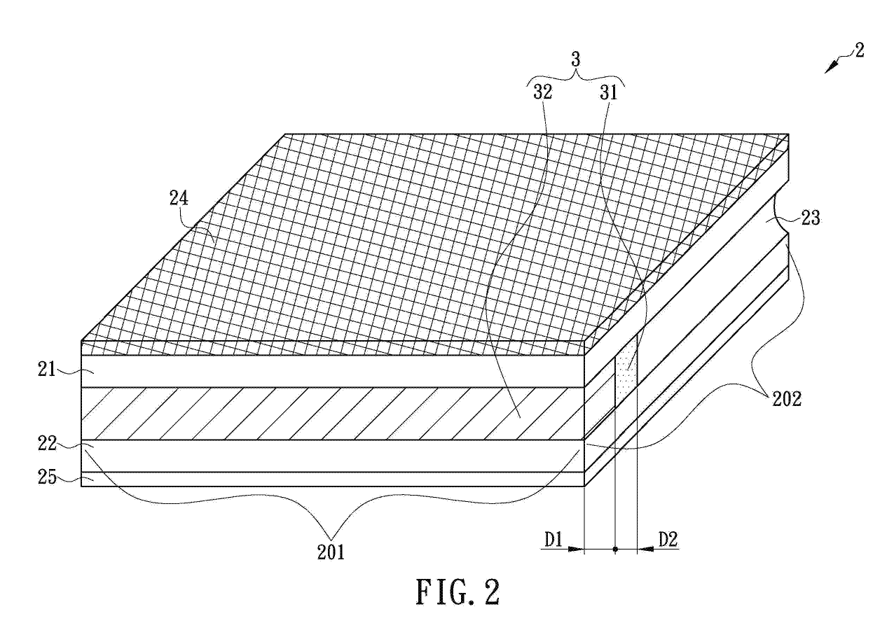

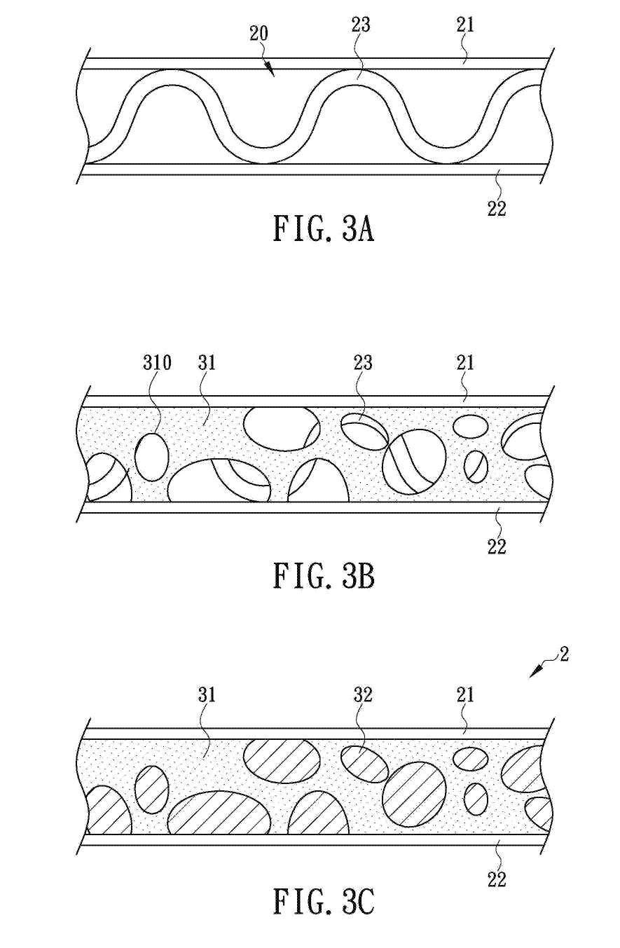

The present invention provides cardboard having edges sealed with a mixture of a hot-melt adhesive and wax. Referring to FIG. 2 and FIG. 3A for a preferred embodiment of the present invention, the cardboard 2 at least includes a first surface sheet 21 (For example, kraft paper), a second surface sheet 22, and at least one intermediate core material 23. The intermediate core material 23 is provided between the surface sheets 21, 22 and is bent or curved (in the case where the cardboard 2 is a corrugated cardboard, the intermediate core material 23 may be composed of a stack of one to three layers of curved or corrugated paper) such that each of the top and bottom sides of the intermediate core material 23 forms at least one interstitial space 20 (referred to as air columns between the core material 23 and the surface sheets 21, 22) with the corresponding surface material 21, 22. The surface sheets 21, 22 have a pair of corresponding edges that form an edge opening 201 therebetween. The interstitial spaces 20 are in communication with the edge opening 201.

According to the present invention, the interstitial spaces 20 are provided therein with an edge-sealing structure 3 for sealing the edge opening 201. The edge-sealing structure 3 includes a primer layer and a sealing layer. The primer layer is formed by an adhesive mixture 31 and the sealing layer is formed by a sealing mixture 32. The adhesive mixture 31 is made by mixing a hot-melt adhesive with wax, wherein the hot-melt adhesive may be low-density polyethylene (LDPE) or ethylene vinyl acetate (EVA) but is not limited to the foregoing. For example, the hot-melt adhesive may be a mixture of different hot-melt adhesives. The wax may be a soft microcrystalline wax or a fully refined wax but is also not limited to the foregoing. To easily identify the compositions of the cardboard 2 claimed in this application, FIGS. 2 to 3C use sloping lines, grid lines, and dots thereon for clearly referring to the sealing mixture 32, the waterproof layer 24 coated on the outer side of the first surface sheet 21, and the adhesive mixture 31 of the cardboard 2, respectively, which vary in wax content. The core feature of the present invention is to incorporate such properties of the hot-melt adhesive as “adhesiveness” and “not being absorbable by the intermediate core material 23” and the “waterproofing” property of the wax into the edge-sealing structure 3. As long as the hot-melt adhesive and the wax satisfy the above property requirements, their constituent materials may be adjusted as needed.

The details and arrangement of the edge-sealing structure 3 are described below regarding FIG. 2 and FIGS. 3A to 3C. The hot-melt adhesive in the adhesive mixture 31 constitutes 10% to 65%, preferably 30% to 65%, by weight of the adhesive mixture 31. After heating and mixing the hot-melt adhesive and wax making up the adhesive mixture 31, the resulting mixture is filled into the interstitial spaces 20 through the edge opening 201 by spray coating and is thus adhesively bonded to, and hence located between, the surface sheets 21, 22 and the intermediate core material 23. In consequence, the surface sheets 21, 22 and the intermediate core material 23 are adhesively bonded together and form a single unit. The adhesive mixture 31 is so adhesive that a plurality of voids 310 are formed in a central portion of the adhesive mixture 31 due to surface tension when the adhesive mixture 31 attaches to the inner sides of the surface sheets 21, 22, and that therefore the adhesive mixture 31 forms the porous primer layer in the edge opening 201 as shown in FIG. 3B. The shape, size and number of voids in the primer layer are dependent on the quantity of hot melt adhesive in the adhesive mixture; microscopic appearance of the primer layer could range from a fibrous structure resembling spider webs to a mushy structure resembling melted marshmallows.

The sealing mixture 32 is also made by mixing the hot-melt adhesive with the wax, wherein the hot-melt adhesive constitutes 5% to 40%, preferably 5% to 30%, by weight of the sealing mixture 32. The weight percentage of the hot-melt adhesive in the sealing mixture 32 is lower than that of the hot-melt adhesive in the adhesive mixture 31 such that the sealing mixture 32 is less adhesive and more fluid than the adhesive mixture 31. The sealing mixture 32 is spray-coated on the primer layer (the adhesive mixture 31) to fill up at least the voids 310 in the primer layer (the adhesive mixture 31) that correspond to the edge opening 201 (see FIGS. 3B and 3C), thereby forming the sealing layer that seals the edge opening 201 of the cardboard 2 in a watertight manner. In this preferred embodiment of the present invention, the sealing mixture 32 covers the entire outer side of the primer layer (the adhesive mixture 31), i.e., the side facing the edge opening 201 (see FIG. 2), as a waterproof structure coated on the primer layer.

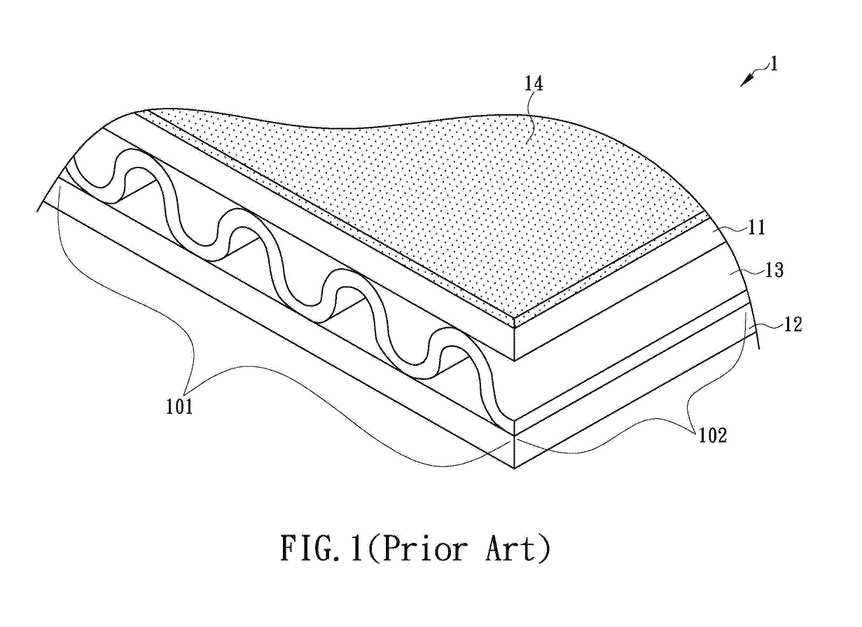

The adhesive mixture 31, which is more adhesive than the sealing mixture 32, can adhere tightly to the inner sides of the surface sheets 21, 22 such that the wax in the adhesive mixture 31 will not be adsorbed by the surface sheets 21, 22. This technical feature enables the porous primer layer to be formed in the interstitial spaces 20 and be coated with the sealing mixture 32 to solve the problem of the prior art that, as stated in Description of Related Art and shown in FIG. 1, the interior of the edge opening 101 of the conventional corrugated cardboard cannot be coated with wax. In addition, with the sealing mixture 32 being less adhesive than the adhesive mixture 31 and hence capable of evenly covering and seeping into the primer layer to fill up the voids 310, the primer layer (the adhesive mixture 31) and the sealing mixture 32 jointly form a perfectly watertight double-layer protective structure that ensures moisture resistance of the cardboard 2 by preventing moisture from penetrating the surface sheets 21, 22 or the intermediate core material 23 through the edge opening 201.

Apart from enhancing moisture resistance of the cardboard 2, the edge-sealing structure 3 contributes to higher thermal insulation and heat resistance. Also, the edge-sealing structure 3 adds little to the weight of the cardboard 2 and allows the cardboard 2 to be transported with ease and folded into corrugated boxes of various shapes or specifications without difficulty. Besides, the edge-sealing structure 3 is easy to implement, for a manufacturer only must arrange two spray nozzles sequentially on a machine configured for conveying the cardboard 2, and the edge-sealing structure 3 can be rapidly formed by spray-coating the edge opening 201 with the adhesive mixture 31 and the sealing mixture 32 one after the other.

While the cardboard 2 in the preferred embodiment described herein is implemented as corrugated cardboard, i.e., with the intermediate core material 23 having a corrugated configuration, the edge-sealing structure 3 is applicable to and can form a watertight protective layer in all cardboard structures that are formed by multiple layers of paper materials and that have voids in the edges. Furthermore, once the edge-sealing structure 3 is formed in the cardboard 2, the cardboard 2 can be folded either manually or by a machine to form a corrugated box. As the process of “scoring a piece of cardboard at different positions to facilitate folding into a corrugated box” is well known in the art, a description of the scoring process is omitted herein.

In the preferred embodiment of the present invention, referring to FIG. 2, the top side of the cardboard 2 (i.e., the outer side of the first surface sheet 21) may be further coated with the wax to form a waterproof layer 24. After the cardboard 2 is folded into a corrugated box, the waterproof layer 24 constitutes the outer side of the corrugated box to protect the box against dampness and moisture.

Moreover, once the waterproof layer 24 is formed on the top side of the cardboard 2 by coating the top side with wax and allowing the wax to solidify, a buffer layer 25 may be additionally provided on (For example, adhesively bonded with glue or a hot-melt adhesive to) the outer side of the second surface sheet 22. After the cardboard 2 is folded into a corrugated box, the buffer layer 25 constitutes the inner side of the corrugated box (i.e., the side facing the goods in the box). The buffer layer 25 may be a pad made of a foamed material such as expandable polyethylene (EPE). EPE is anti-static, impact-resistant, shock-absorbent, resistant to deformation, recyclable, and therefore helpful in improving thermal, electrical, and acoustic insulation of the cardboard 2 (and of the corrugated box made thereof).

To make the cardboard 2 even more resistant to impact, the buffer layer 25 may be formed by multiple layers of foamed materials. For example, based on the densities of the foamed materials used, the second surface sheet 22 may be adhesively bonded with a high-density foamed material, a medium-density foamed material, and a low-density foamed material (For example, EPE), in that order. The thickness of the multilayer buffer layer 25 may range from 2 cm to 6 cm. This buffer layer 25 can greatly increase the structural strength and pressure-bearing capacity (together with thermal and acoustic insulation) of the cardboard 2 so that a corrugated box formed by the cardboard 2 is less likely to deform, tear, or break when subjected to external impact.

Referring again to FIG. 2, the direction in which the intermediate core material 23 extends in a wavy manner is referred to as the “corrugation direction” of corrugated cardboard. The edge opening 201 is formed along an edge of the cardboard 2 that is parallel to the corrugation direction, whereas a corrugation-direction opening 202 is formed along an edge of the cardboard 2 that is perpendicular to the corrugation direction. Both the edge opening 201 and the corrugation-direction opening 202 are in communication with the interstitial spaces 20. In the preferred embodiment of the present invention, the edge-sealing structure 3 is preferentially provided in the edge opening 201, which is more open and hence more susceptible to moisture than the corrugation-direction opening 202. To achieve thorough water tightness, an additional edge-sealing structure 3 may be provided, in the same way as described above, in a portion of the interstitial spaces 20 that is adjacent to the corrugation-direction opening 202. When all the edges of the cardboard 2 are sealed by their respective edge-sealing structures 3, air circulation between the interior of the cardboard 2 and the outside is cut off to provide even higher thermal insulation, which is advantageous to the transport of seafood, fresh produce, wine, flowers, and other goods that need to be thermally insulated during transportation.

According to actual measurement conducted by the inventor of the present invention, an edge-sealing structure 3 created by the method disclosed herein can form a perfectly watertight protective layer when its thickness is about 1 to 5 cm (For example, the thickness D1 of the adhesive mixture 31 is 1 to 2 cm, and so is the thickness D2 of the sealing mixture 32). It can therefore be inferred that the hot-melt adhesive and the wax are not required in large quantities. Compared with the conventional approach of submerging an entire piece of cardboard in wax, the present invention features a significant reduction in cost so that corrugated boxes can achieve higher resistance to moisture at lower cost than those made of the conventional corrugated cardboard.

Aside from being folded into corrugated boxes for use in freight transport, the cardboard 2 of the present invention may function as a building material as well. Thanks to the edge-sealing structure 3, the waterproof layer 24, and the buffer layer 25, the cardboard 2 performs well in terms of waterproofness, thermal and acoustic insulation, impact resistance, and pressure bearing while staying lightweight, and this combination of advantageous properties allows the resulting building material to be used flexibly (For example, to impart thermal insulation and moisture resistance to a wall of a building).

The embodiment described above is but a preferred one of the present invention and does not impose limitation on the technical features of the invention. All equivalent changes based on the technical contents disclosed herein and readily conceivable by a person of ordinary skill in the art should fall within the scope of the present invention.

What is claimed is:

1. Cardboard with edges sealed with a mixture of a hot-melt adhesive and wax, wherein the cardboard comprises a first surface sheet, a second surface sheet, and an intermediate core material provided between the surface sheets; the intermediate core material has a top side and a bottom side each forming at least one interstitial space with a corresponding one of the surface sheets; the surface sheets have a pair of corresponding edges that form an edge opening therebetween; and the edge opening is in communication with the interstitial spaces; the cardboard being characterized in that the interstitial spaces are provided therein with an edge-sealing structure for sealing the edge opening, the edge-sealing structure comprising:
a primer layer, formed by an adhesive mixture, and the adhesive mixture made by mixing the hot-melt adhesive with the wax, wherein the hot-melt adhesive makes up 10% to 65% by weight of the adhesive mixture, the adhesive mixture is applied to the edge opening to adhesively bond the surface sheets and the intermediate core material together, and the adhesive mixture when cured forms the primer layer with a plurality of voids; and
a sealing layer, formed by a sealing mixture, and the sealing mixture made by mixing the hot-melt adhesive with the wax, wherein the hot-melt adhesive makes up 5% to 40% by weight of the sealing mixture, the hot-melt adhesive in the sealing mixture has a lower weight percentage than the hot-melt adhesive in the adhesive mixture such that the sealing mixture is less adhesive than the adhesive mixture, and the sealing mixture is applied to the primer layer to fill up said voids in the primer layer that correspond to the edge opening, thereby forming the sealing layer.

2. The cardboard of claim 1, wherein the hot-melt adhesive makes up 30% to 65% by weight of the adhesive mixture.

3. The cardboard of claim 2, wherein the hot-melt adhesive makes up 5% to 30% by weight of the sealing mixture.

4. The cardboard of claim 1, wherein the edge-sealing structure has a thickness ranging from 1 cm to 5 cm.

5. The cardboard of claim 2, wherein the edge-sealing structure has a thickness ranging from 1 cm to 5 cm.

6. The cardboard of claim 3, wherein the edge-sealing structure has a thickness ranging from 1 cm to 5 cm.

7. The cardboard of claim 4, wherein the first surface sheet has an outer side coated with the wax to form a waterproof layer.

8. The cardboard of claim 5, wherein the first surface sheet has an outer side coated with the wax to form a waterproof layer.

9. The cardboard of claim 6, wherein the first surface sheet has an outer side coated with the wax to form a waterproof layer.

10. The cardboard of claim 7, wherein the cardboard is a corrugated cardboard, the intermediate core material has a corrugated configuration and extends in a wavy manner in a direction defined as a corrugation direction, and the edge of the cardboard, along which the edge opening is located, is parallel to the corrugation direction.

11. The cardboard of claim 8, wherein the cardboard is a corrugated cardboard, the intermediate core material has a corrugated configuration and extends in a wavy manner in a direction defined as a corrugation direction, and the edge of the cardboard, along which the edge opening is located, is parallel to the corrugation direction.

12. The cardboard of claim 9, wherein the cardboard is a corrugated cardboard, the intermediate core material has a corrugated configuration and extends in a wavy manner in a direction defined as a corrugation direction, and the edge of the cardboard, along which the edge opening is located, is parallel to the corrugation direction.

13. The cardboard of claim 10, wherein the cardboard has another edge, which is perpendicular to the corrugation direction and is formed with a corrugation-direction opening, the corrugation-direction opening is also in communication with the interstitial spaces, and the interstitial spaces are provided therein with another said edge-sealing structure adjacent to the corrugation-direction opening.

14. The cardboard of claim 11, wherein the cardboard has another edge, which is perpendicular to the corrugation direction and is formed with a corrugation-direction opening, the corrugation-direction opening is also in communication with the interstitial spaces, and the interstitial spaces are provided therein with another said edge-sealing structure adjacent to the corrugation-direction opening.

15. The cardboard of claim 12, wherein the cardboard has another edge, which is perpendicular to the corrugation direction and is formed with a corrugation-direction opening, the corrugation-direction opening is also in communication with the interstitial spaces, and the interstitial spaces are provided therein with another said edge-sealing structure adjacent to the corrugation-direction opening.

16. The cardboard of claim 13, wherein the second surface sheet has an outer side provided with a buffer layer.

17. The cardboard of claim 14, wherein the second surface sheet has an outer side provided with a buffer layer.

18. The cardboard of claim 15, wherein the second surface sheet has an outer side provided with a buffer layer.

19. The cardboard of claim 16, wherein the buffer layer is made of expandable polyethylene (EPE).

20. The cardboard of claim 17, wherein the buffer layer is made of expandable polyethylene (EPE).

21. The cardboard of claim 18, wherein the buffer layer is made of expandable polyethylene (EPE).
